(19) United States
(12) Patent Application Publication
(10) Pub. No.: US 2026/0170848 A1
(43) Pub. Date: Jun. 18, 2026

(54) METHOD OF OBJECT RECOGNITION BASED ON SENSOR FUSION, AND A VEHICLE IMPLEMENTING THE SAME

(71) Applicants: HYUNDAI MOTOR COMPANY, Seoul (KR); KIA CORPORATION, Seoul (KR)

(72) Inventors: Hun Min Lee, Hwaseong-si (KR); Kyeong Jin Jeon, Hwaseong-si (KR)

(73) Assignees: HYUNDAI MOTOR COMPANY, Seoul (KR); KIA CORPORATION, Seoul (KR)

(21) Appl. No.: 19/399,251

(22) Filed: Nov. 24, 2025

(30) Foreign Application Priority Data
Dec. 17, 2024 (KR) 10-2024-0188435

(51) Int. Cl. G06V 20/58; G06V 10/25

(52) U.S. Cl. CPC G06V 20/58; G06V 10/25; G06V 2201/07

(57) ABSTRACT

A method for recognizing an object using sensor fusion includes: identifying, as a candidate track area associated with a road facility, a track area including a static object on a road. The static object is detected by a first sensor configured to generate point cloud data. The method further includes: generating fusion information including first verification data and second verification data in relation to the candidate track area; evaluating reliability of the candidate track area based on the fusion information; and determining the candidate track area as a track area including a static object of the road facility based on the reliability.

### CROSS-REFERENCE TO RELATED APPLICATION

This application claims the priority to and the benefit of Korean Patent Application No. 10-2024-0188435, filed on Dec. 17, 2024, the entire contents of which are incorporated herein by reference.

### TECHNICAL FIELD

The present disclosure relates to a method of object recognition based on sensor fusion and a vehicle for implementing the same. More particularly, the present disclosure relates to a method of object recognition based on sensor fusion to improve the robustness of object recognition through various types of sensor fusion and a vehicle for implementing the same.

### BACKGROUND

Recently, vehicles with various functions for driving convenience have been commercialized. To this end, autonomous driving functions are supported in vehicles. The autonomous driving functions are being developed to minimize driver intervention or to allow vehicles to control driving without driver intervention.

The vehicle may recognize the surrounding environment acquired by various types of heterogeneous sensors and may identify situations around the vehicle based on the recognized surrounding environment. The vehicle may establish a control plan for autonomous driving corresponding to the identified situations and may control an actuator of the vehicle.

The recognized surrounding environment may include, for example, dynamic object and static object. The dynamic object may include vehicles, bicycles, and pedestrians traveling on a road. The static object may be, for example, road facilities. The vehicle detects static object for longitudinal positioning and lateral positioning. Sensors for detecting static object may use LiDAR sensors and image sensors. The LiDAR sensor detects static object based on sizes, heights from the road surface, and presence or absence of static properties, and the vehicle may generate a track area based on the detected static object. The image sensor may acquire image data of the surrounding environment, and the vehicle may identify static object based on a database including image data and information on the static object constructed through learning to generate the track area.

Because the LiDAR sensor has a characteristic of providing sensor data with noise due to crosstalk, a height of an object detected by the LiDAR sensor may be recognized inaccurately. Furthermore, crosstalk is severe in objects located at a close distance from a vehicle, and information on the objects may be generated inaccurately.

Objects detected by the image sensor, such as road facilities, may be identified using a database constructed through learning. To this end, the database should include data related to road facilities of various shapes and colors by region. However, the construction of a database for managing various road facilities has limitations due to the vast amount of data and extensive work required. In addition, the recognition performance of the image sensor may be degraded due to the environment and surrounding situations that impair image recognition.

Due to the limitations of the sensor characteristics and the database, the fusion of the LiDAR sensor and the image sensor may not have robustness. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

The present disclosure is directed to providing a method of object recognition based on sensor fusion to improve the robustness of object recognition through various types of sensor fusion and a vehicle for implementing the same.

The technical problems of the present disclosure are not limited to the above-described technical problems. Other technical problems that are not described may be obviously understood by those having ordinary skill in the art to which the present disclosure pertains from the following description.

According to the present disclosure, a method for recognizing an object using sensor fusion includes: identifying, as a candidate track area associated with a road facility, a track area including a static object on a road. The static object is detected by a first sensor configured to generate point cloud data. The method further includes generating fusion information including first verification data and second verification data associated with the candidate track area. The method further includes evaluating reliability of the candidate track area based on the fusion information. The method further includes determining the candidate track area as a track area including a static object of the road facility based on the reliability. The first verification data is generated to determine whether the candidate track area is a drivable area based on fusion between at least one of a first recognition area or map information of a sensor for static object different from the road facility and the candidate track area. Also, the second verification data is generated to determine whether the static object is the candidate track area estimated as the road facility based on fusion between at least one of a second recognition area or the map information of a second sensor detecting image data including the static object identical to the road facility and the candidate track area.

According to an embodiment of the present disclosure, identifying the candidate track area may include identifying the track area including the static object located at a predetermined height from a ground of the road as the candidate track area.

According to an embodiment of the present disclosure, the first sensor may include a LiDAR sensor or a radar sensor.

According to an embodiment of the present disclosure, the recognition area of the sensor used to generate the first verification data may include the recognition area of the first sensor or the second sensor.

According to an embodiment of the present disclosure, the different static object detected in the first recognition area may include boundary markers that guide driving on the road. Also, the first verification data may be generated to have level data related to the determination of the drivable area based on the candidate track area being determined as the drivable area. The candidate track area intersects an array form of the boundary marker detected in the first recognition area.

According to an embodiment of the present disclosure, the map information may include a degree of dynamic estimation, based on a location of the road on which the static object and a dynamic object are present, and a trajectory of the dynamic object. When the degree of dynamic estimation around the candidate track area is greater than or equal to a dynamic threshold value, the first verification data may be generated to have level data related to the determination of the drivable area based on the candidate track area being determined as the drivable area.

According to an embodiment of the present disclosure, the second verification data may be generated to have level data related to the estimation of the road facility based on the candidate track area being matched to the second recognition area including an object identical to the road facility.

According to an embodiment of the present disclosure, the map information may include a degree of static estimation, based on a location of the road on which the static object and a dynamic object are present, and a location of the static object. When the degree of static estimation around the candidate track area is greater than or equal to a static threshold value, the second verification data may be generated to have level data related to the estimation of the road facility based on the candidate track area being estimated as the road facility.

According to an embodiment of the present disclosure, level data of the second verification data based on the fusion of the second recognition area may be generated to have a higher reliability score than level data of the second verification data based on the fusion of the map information and level data of the first verification data. Level data about the candidate track area based on the first sensor may be generated to have a lower reliability score than the level data of the second verification data based on the fusion of the map information and the level data of the first verification data. Also, evaluating the reliability may include evaluating the reliability of the candidate track area based on an accumulated reliability score of the level data.

According to an embodiment of the present disclosure, the fusion of the candidate track area for generating the second verification data uses at least one of the second recognition area, the map information, or external information. The external information may be received from at least one of a transportation device, a traffic infrastructure device, or a support server around a device equipped with a sensor and may include facility information related to the road facility.

According to another embodiment of the present disclosure, a vehicle configured to perform object recognition based on sensor fusion includes a sensor unit including a first sensor configured to generate point cloud data and a second sensor configured to generate image data in relation to detection of a surrounding environment. The vehicle further includes a memory configured to store at least one instruction. The vehicle further includes at least one processor configured, by executing the at least one instruction stored in the memory, to identify a track area including a static object on a road detected by the first sensor as a candidate track area related to a road facility. The at least one processor is further configured to generate fusion information including first verification data and second verification data in relation to the candidate track area. The at least one processor is further configured to evaluate reliability of the candidate track area based on the fusion information. The at least one processor is further configured to determine the candidate track area as a track area including a static object of the road facility based on the reliability. The first verification data is generated to determine whether the candidate track area is a drivable area based on fusion between at least one of a first recognition area or map information of a sensor for static object different from the road facility and the candidate track area. Also, the second verification data is generated to determine whether the static object is the candidate track area estimated as the road facility based on fusion between at least one of a second recognition area or the map information of a second sensor including the static object identical to the road facility and the candidate track area.

The features briefly summarized above for this disclosure are only some aspects of the detailed description of the present disclosure and are not intended to limit the scope of the present disclosure.

### BRIEF DESCRIPTION OF THE DRAWINGS

The above and other objects, features, and advantages of the present disclosure should become more apparent to those of ordinary skill in the art by describing embodiments thereof in detail with reference to the accompanying drawings, in which:

FIG. 1 is a diagram illustrating a vehicle communicating with another device to transmit and receive data;

FIG. 2 is a diagram illustrating modules constituting a vehicle according to an embodiment of the present disclosure;

FIG. 3 is a diagram illustrating modules constituting a server according to the present disclosure;

FIG. 4 is a flowchart illustrating a method of object recognition based on sensor fusion according to another embodiment of the present disclosure;

FIG. 5 is a diagram illustrating road facilities;

FIG. 6 is a diagram illustrating the generation of first verification data based on fusion between a boundary marker detected in a first recognition area of a sensor and a candidate track area;

FIG. 7 is a diagram illustrating the generation of first verification data based on fusion between map information and a candidate track area;

FIG. 8 is a diagram illustrating the generation of second verification data based on fusion between a road facility detected in a second recognition area of a second sensor and a candidate track area;

FIG. 9 is a diagram illustrating the generation of second verification data based on the fusion between map information and a candidate track area;

FIG. 10 is a diagram illustrating the reliability evaluation of a candidate track area and the determination of a track area including a facility according to an embodiment of the present disclosure; and

FIG. 11 is a diagram illustrating the determination of a track area including a facility according to the recognition of individual sensors.

### DETAILED DESCRIPTION

Hereinafter, embodiments of the present disclosure are described in detail with reference to the accompanying drawings so that those having ordinary skill in the art may easily implement the present disclosure. However, the present disclosure may be implemented in various different ways and is not limited to the embodiments described therein.

In describing embodiments of the present disclosure, well-known functions or constructions have not been described in detail because they may unnecessarily obscure the understanding of the present disclosure. The same or equivalent constituent elements in the drawings are denoted by the same reference numerals, and a repeated description of the same elements has been omitted.

In the present disclosure, when an element is simply referred to as being “connected to”, “coupled to” or “linked to” another element, this may mean that an element is “directly connected to”, “directly coupled to”, or “directly linked to” another element or is connected to, coupled to or linked to another element with the other intervening element disposed therebetween. In addition, when an element “includes” or “has” another element, this means that one element may further include another element without excluding another component unless specifically stated otherwise.

In the present disclosure, the terms, such as “first,” “second,” etc., are only used to distinguish one element from another and do not limit the order or the degree of importance between the elements unless specifically mentioned. Accordingly, a first element in an embodiment could be termed as a second element in another embodiment, and similarly, a second element in an embodiment could be termed as a first element in another embodiment, without departing from the scope of the present disclosure.

In the present disclosure, elements that are distinguished from each other are for clearly describing each feature, and do not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment including a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them should become apparent with reference to embodiments described below in detail in conjunction with the accompanying drawings. The present disclosure, however, may be embodied in many different forms and should not be constructed as being limited to the embodiments set forth herein. Rather, these embodiments are provided so that the present disclosure can be complete and can fully convey the scope of the present disclosure to those having ordinary skill in the art.

In the present disclosure, the terms, such as “A or B”, “at least one of A and B”, “at least one of A or B”, “A, B, or C”, “at least one of A, B, and C”, “at least one of A, B, or C” and “at least one of A, B, C, or combination thereof”, may include any one or all possible combinations of the items listed together in the corresponding one of the phrases.

In the present disclosure, the terms related to location relations used in the present disclosure, such as “upper”, “lower”, “left”, and “right”, are employed for the convenience of explanation, and in a case that drawings illustrated in the present specification are inversed, the location relations described in the present disclosure may be inversely understood. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

Hereinafter, embodiments of the present disclosure are described with reference to the accompanying drawings.

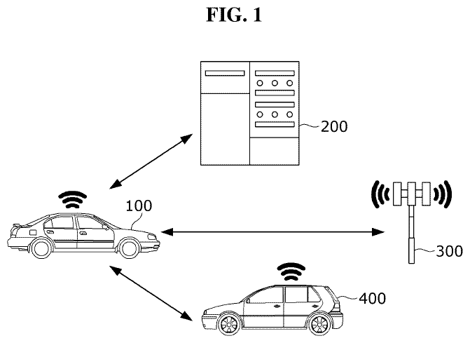

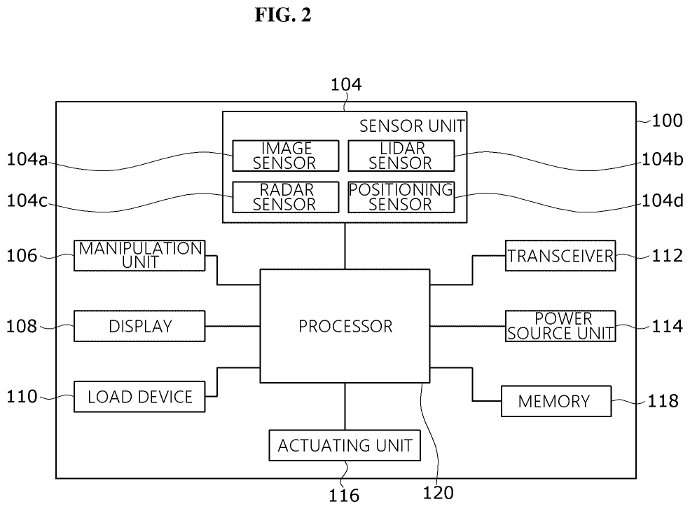

Hereinafter, a vehicle for implementing object recognition based on sensor fusion is described with reference to FIGS. 1 and 2.

FIG. 1 is a diagram illustrating a vehicle communicating with another device to transmit and receive data.

Referring to FIG. 1, a vehicle 100 may be driven by electrical energy or fossil energy. In the case of electrical energy, the vehicle 100 may be, for example, a pure battery-based vehicle driven only by a high-voltage battery or a gas-based fuel cell as an energy source. In addition, the fuel cell may utilize various forms of gas that may generate electrical energy, and the vehicle 100 may be filled with gas in a liquefied state, for example. Here, the gas may be, for example, hydrogen. However, the present disclosure is not limited thereto, and various gases can be applied. In the case of fossil energy, the vehicle 100 is driven based on fuel such as gasoline, diesel, or liquefied gas and may be equipped with an engine that drives an actuating unit 116 by combustion of the fuel. The engine may be included in a power source unit 114 from the perspective of providing a driving rotational force of wheels to a wheel driving unit. As another example, the vehicle 100 may selectively utilize energy from a fossil fuel-based internal combustion engine and an electric battery to drive the actuating unit 116 and may be a hybrid-type vehicle.

The vehicle 100 may be a movable device. The vehicle 100 is a ground vehicle that travels on the ground and may be a typical passenger or commercial vehicle, a purpose built vehicle (PBV), etc. The vehicle 100 may be a four-wheeled vehicle, such as a passenger car, an SUV, or a small truck, and may be a vehicle with more than four wheels, such as a bus, a large truck, a container transportation vehicle, a heavy equipment vehicle, etc. The vehicle 100 may be a robot in a broad sense, such as a means of transportation, and the robot may be moved using wheels, tracks, or other movement modules.

The vehicle 100 may be driven by being controlled through manual driving by the user or autonomous driving. The autonomous vehicle 100 may be implemented as semi-autonomous driving or fully autonomous driving. The fully autonomous driving may be provided as autonomous movement in which a processor 120 of the vehicle 100 takes full control without user intervention, even in uncertain driving situations. The semi-autonomous driving may be provided as autonomous movement that requires driver intervention depending on specific driving situations. The semi-autonomous driving may be implemented such that the processor 120 deactivates autonomous driving upon the occurrence of the above situations and transfers control to a user, thereby enabling the user to perform manual driving. According to the level of the autonomous driving defined by the Society of Automotive Engineers (SAE), the semi-autonomous driving may correspond to autonomous driving levels 1 to 4, and the fully autonomous driving corresponds to level 5.

Meanwhile, the vehicle 100 may communicate with other devices 200 and 300 or other vehicles 400. Other devices may include, for example, a server 200 that supports various controls, state management, and driving of the vehicle 100, an intelligent transportation system (ITS) device 300 for receiving information from the ITS, various types of user devices, etc. The server 200 is, for example, an external device operated by a vehicle manufacturer or provided to service a driving support function and may receive connected data of the vehicle 100 or transmit data required for manual and autonomous driving. In order to support the driving and various services of the vehicle 100, the server 200 may transmit various types of information and software modules used for controlling the vehicle 100 to the vehicle 100 in response to requests and data transmitted from the vehicle 100 and the user device.

The ITS device 300 is, for example, a road side base station (RSU), and the ITS device 300 may exchange vehicle recognition data, driving control and state data, environmental data around the vehicle, map data, etc., with the vehicle 100 through vehicle-to-infrastructure (V2I) communication to assist the user driving his or her own vehicle or support the autonomous driving of the vehicle 100. In the present disclosure, the ITS device 300 may be referred to as a traffic infrastructure device. The vehicle 100 may exchange the data listed above with another vehicle 400 through vehicle-to-vehicle (V2V) communication to support manual driving or autonomous driving.

The vehicle 100 may communicate with another vehicle or another device based on cellular communication, wireless access in vehicular environment (WAVE) communication, dedicated short range communication (DSRC) or short-range communication, or other communication methods.

For example, the vehicle 100 may use a cellular communication network such as long term evolution (LTE), 5th generation (5G), wireless fidelity (WiFi), or WAVE for communication with the server 200, the ITS device 300, and other vehicles 400. As another example, DSRC, etc., used in the vehicle 100 may be used for communication between vehicles. The communication method between the vehicle 100, the server 200, the ITS device 300, other vehicles 400, and the user devices is not limited to the above-described embodiment.

FIG. 2 is a diagram illustrating modules constituting a vehicle according to an embodiment of the present disclosure.

The vehicle 100 may include a sensor unit 104, a manipulation unit 106, a display 108, a load device 110, and a transceiver 112.

The sensor unit 104 may include various types of sensors to detect various states and situations occurring in an external surrounding environment, an internal system, a user operation, and a boarding space of the vehicle 100.

Specifically, the sensor unit 104 may be equipped with an externally-facing image sensor 104a, a light detection and ranging (LiDAR) sensor 104b, a radar sensor 104c, etc. to recognize dynamic and static object present around the vehicle 100.

The image sensor 104a may recognize an external object as an image while the vehicle 100 is in use, may generate image data, and may transmit the image data to the controller 120. The image sensor 104a may be installed on multiple parts of the vehicle 100, so multiple images or multi-views of the surrounding environment of the vehicle 100 may be acquired.

The LiDAR sensor 104b may generate point cloud data for objects around the vehicle 100 and transmit the generated point cloud data to the controller 120. The point cloud data includes three-dimensional information on the objects, and the point cloud data may be referred to as LiDAR data in the present disclosure. In the present disclosure, the LiDAR sensor 104b is exemplified as being mounted, but in other examples, the LiDAR sensor 104b may be omitted. The radar sensor 104c may emit electromagnetic waves of a specific frequency around the vehicle 100 to detect the presence of external objects and their relative distances, speeds, directions, etc. and may generate radar data through the electromagnetic waves reflected from the external objects. The radar data may be generated as point cloud data similar to the LiDAR data. In the present disclosure, the sensor for generating the point cloud data may be exemplified as one of the LiDAR sensor 104b and the radar sensor 104c.

In addition, the sensor unit 104 may include a positioning sensor 104d for confirming the position of the vehicle 100. The positioning sensor 104d is, for example, a global positioning system (GPS) sensor or a global navigation satellite system (GNSS) sensor but is not limited thereto. In addition, the sensor unit 104 may include an attitude sensor (not illustrated). The attitude sensor may detect, for example, a three-axis state of the vehicle 100, for example, yaw, pitch, and roll, and may output various vehicle attitude states based on the above-described factors. The attitude sensor may be formed as, for example, an inertial measurement unit (IMU) sensor, a gyro sensor, etc.

In the present disclosure, the sensors of the sensor unit 104 referred to in the description of the embodiment are mainly described, and sensors that detect various situations not listed herein may be additionally included.

The manipulation unit 106 may be formed as a module for a user to control driving. For example, the manipulation unit 106 may be a steering wheel for manual driving, an automatic or manual transmission actuator, an accelerator pedal, a brake pedal, a gear shift, etc. The manipulation unit 106 may be further provided with an interface for the use, release, and selection of detailed functions of the autonomous driving mode requested by the user so that the user may use the autonomous driving function. The manipulation unit 106 may be formed as, for example, a hard type interface provided at a predetermined location inside the vehicle 100, or a soft type interface that may be touched on the display 108 in order to receive various requests related to autonomous driving.

The display 108 may function as a user interface. The display 108 may display an operation state, a control state, route/traffic information, remaining energy information, content requested by a driver of the vehicle 100, etc. under the control of the processor 120. In addition, the display 108 is formed as a touch screen capable of detecting a driver's input to receive a driver's request that instructs the processor 120.

The load device 110 is mounted on the vehicle 100 and may be a type of non-driving electric device excluding a driving power system such as the wheel driving unit. The load device 110 is an auxiliary device that receives power from the power source unit 114, and the load device 110 may be, for example, an air conditioning system, an indicator lamp system, a lighting system, a seat system, various devices installed in the vehicle 100, etc.

The transceiver 112 may support mutual communication with the server 200, the ITS device 300, the nearby vehicle 300, etc. The transceiver 112 may include a module that processes, for example, cellular communication, WAVE communication, DSRC, etc. In the present disclosure, the transceiver 112 may transmit data generated or stored during driving to the server 200 and may receive data and software modules transmitted from the server 200. The transceiver 112 may also support communication with an electronic device carried by a passenger inside the vehicle 100. In the present disclosure, the vehicle 100 may transmit and receive data utilized in the method according to the present disclosure to and from the outside through the transceiver 112.

In addition, the vehicle 100 may include the power source unit 114 and the actuating unit 116.

The power source unit 114 may generate and supply power and electric power used in a driving power system such as the actuating unit 116 and a non-driving power system. The non-driving power system may be, for example, the sensor unit 104, the manipulation unit 106, the display 108, the load device 110, the transceiver 112, etc., but is not limited thereto, and may include various components that implement sensing, interface, communication, and convenience functions, excluding components directly involved in driving operations.

When the vehicle 100 is driven based on electrical energy, the power source unit 114 may be formed as, for example, an electric battery that is charged from the outside, or a combination of the electric battery and a fuel cell that charges the battery. In the case of the combination of an electric battery and a fuel cell, the power source unit 114 may include a tank that stores a material used to produce power for the fuel cell, for example, liquefied hydrogen. When the vehicle 100 is driven based on fossil energy, the power source unit 114 may be formed as an internal combustion engine. In addition, when the vehicle 100 is a hybrid type, the power source unit 114 may be provided as a combination of an internal combustion engine and an electric battery.

The actuating unit 116 has at least one module that implements driving operations and may perform at least one driving operation among longitudinal control such as acceleration/deceleration, lateral control such as steering, and gear shifting according to a user request from the manipulation unit 106 or a request from the processor 120. Here, the gear shifting may be processed by a manual driving user using a gear transmission or by a request from the processor 120 in autonomous driving.

The actuating unit 116 may include a wheel driving unit, a mechanical component for implementing the driving operation in the wheel driving unit, and an electronic module for executing the driving operation according to a command of the processor 120 by the user's manual operation or the autonomous driving. When the vehicle 100 is operated based on electrical energy, the vehicle 100 may include an assembly for transmitting the requested driving operation to the wheel driving unit. When the vehicle 100 is operated based on fossil energy, the actuating unit 116 may include a transmission and a gear module that transmit the power of the internal combustion engine.

The wheel driving unit may include a plurality of wheels, a driving force generation module for generating and applying a driving force to the wheels or transmitting the driving force, a braking module for decelerating the driving of the wheels, and a steering module for realizing lateral control of the wheels. When the vehicle 100 is driven based on electrical energy, the driving force generation module may be formed as a motor assembly that generates a driving force based on the power output from the electric battery. The braking module of the electric-based vehicle 100 may further have a regenerative braking function.

In addition, the vehicle 100 may include a memory 118 and the processor 120.

The memory 118 may store applications and various types of data for controlling the vehicle 100, and may load applications or read and record data at the request of the processor 120. In the present disclosure, the memory 118 may include an application that determines a track area of a static object detected by a specific sensor as a track area related to facilities on a road (hereinafter, also referred to as road facilities) by using an example according to the present disclosure, i.e., fusion of multiple sensors, fusion with other information, and evaluation of the fused results.

The road facilities may be, for example, structures that provide various types of information for driving the vehicle 100. The road facilities may be installed spaced from each other by a predetermined height from a road surface. Specifically, the road facilities may be a road marker, a traffic sign, a traffic light, etc.

In another example, the road facilities may be special structures that are fixedly or temporarily present on a road. For example, the road facilities may be a tunnel, equipment that is fixed or moved in a construction or dangerous section, or a traffic structure installed in the section. The road facilities installed in a space or a dangerous section may be installed across a driving direction of the road, thereby causing a stop in the driving direction. Other examples of road facilities may be different from the example of road facilities that are in contact with the ground and separated from the ground.

The memory 118 may store various types of information and data utilized in an application that executes object recognition based on sensor fusion according to the present disclosure. For example, the memory 118 may include a database used to generate information on objects detected by the image sensor 104a. The database may manage object information including a type (or class) of objects and detailed data of the objects.

In addition, the memory 118 may include map information. The map information may include, for example, a global map that indicates static object and road information around the driving vehicle 100. The global map may be a high-precision map including, for example, lane-level road information.

In addition, the map information may have occupancy map information indicating a location of a road on which the driving vehicle 100 is traveling as well as the presence of dynamic and static object around the vehicle. The occupancy map information may be, for example, an occupancy grid map.

The occupancy map information may have not only the locations of objects on a road, but also a degree of static estimation and a degree of dynamic estimation for each grid cell of the occupancy map. The degree of static estimation may be a static estimation value that is assigned to the grid cell where the static object is detected and changes over time. The degree of dynamic estimation may be accumulated in a time series manner in the grid cell. As a result, the corresponding grid cell may be related to the location of the static object detected by the sensor. The degree of static estimation for each grid cell may change depending on the behavior of the vehicle 100. The degree of dynamic estimation is assigned to the grid cell where the dynamic object is detected and may be a dynamic estimation value provided according to the grid cell corresponding to the trajectory of the dynamic object. The degree of dynamic estimation changes over time and may be accumulated in a time series manner in the grid cell. In addition, the degree of dynamic estimation for each cell may change according to a change in an area of interest according to the behavior of the vehicle 100.

In addition, the memory 118 may include external information. The external information may be received from at least one of a transportation device, a traffic infrastructure device, or a support server around the vehicle 100 equipped with the sensor unit 104. In the present disclosure, the transportation device, the traffic infrastructure device, and the support server may be exemplified as other vehicles 400, ITS devices 300, and servers 200, respectively. The external information may include facility information related to road facilities. The facility information may include, for example, locations, shapes, and other data of the road facilities.

The processor 120 may perform overall control of the vehicle 100. The processor 120 may be configured to execute applications and instructions stored in the memory 118. The processor 120 may generate control instructions for components of the vehicle 100 according to driving control requests in manual driving and autonomous driving. The components may be at least one of the various members described in FIG. 2.

The processor 120 may execute various types of processing related to object recognition based on sensor fusion according to the present disclosure. Specifically, the processor 120 may perform processing to identify a track area including a static object of a road detected by a first sensor as a candidate track area related to a road facility. In the present disclosure, the first sensor may be the LiDAR sensor 104b or the radar sensor 104c that provides nearby objects as point cloud data. The second sensor may be the image sensor 104a that provides nearby objects as image data.

The processor 120 may execute processing for generating fusion information including first verification data and second verification data in relation to the candidate track area. In addition, the processor 120 may perform processing for evaluating the reliability of the candidate track area based on the fusion information. The processor 120 may perform processing for determining the candidate track area as a track area that includes a static object of a facility based on the reliability. A detailed description of the generation of the fusion information and the reliability evaluation is described below.

The processor 120 is illustrated as a single processing module, as in FIG. 2, to execute the processing described above. As another example, the processor 120 may be formed with a plurality of processing modules, and the processing may be distributed and processed in a plurality of modules.

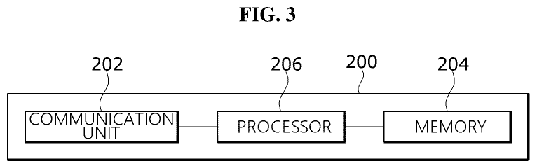

FIG. 3 is a diagram illustrating modules constituting a server according to the present disclosure.

The server 200 may transmit response data according to a request from the vehicle 100 to the vehicle 100 and may also transmit information for supporting an application built into the vehicle 100 and the driving of the vehicle to the vehicle 100. The server 200 may include a communication unit 202, a memory 204, and a processor 206.

The communication unit 202 may transmit and receive data to and from the external device, support mutual communication with the vehicle 100 in the present disclosure and may exchange data with the vehicle 100.

The memory 204 may store programs and various types of data for operating the server 200, and load programs or read and record data at the request of the processor 206. The memory 204 may store and manage a program for processing a request from the vehicle 100, an application built into the vehicle 100, and information for supporting driving. The memory 118 may store, for example, a database, a high-precision map, and external information used to identify an object detected by the image sensor 104a.

The processor 206 may perform overall control of the server 200. The server 200 may be configured to execute programs and instructions stored in the memory 204. The processor 206 may execute the programs and may process and respond to the user's request transmitted from the vehicle 100. For example, the processor 206 may transmit the database, the high-precision map, and the external information used to identify the object detected by the image sensor 104a at the request of the vehicle 100.

In the present disclosure, the processor 206 is exemplified as being formed as a single processing module. As another example, the processor 206 may be distributed into multiple processing modules, and the above-described processing may be executed by a distributed processing model.

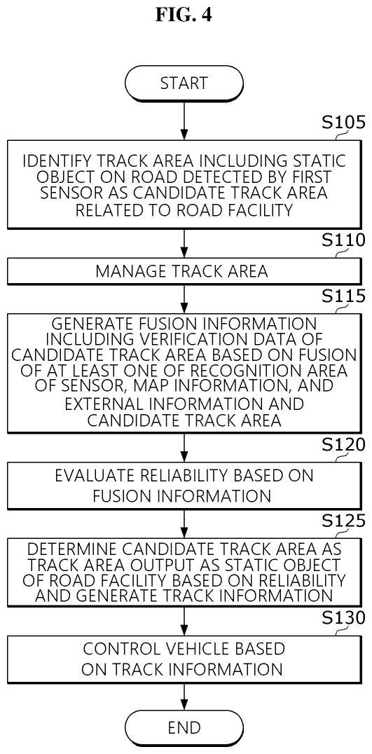

Hereinafter, a method of object recognition based on sensor fusion according to another embodiment of the present disclosure is described in detail with reference to FIG. 4. FIG. 4 is a flowchart illustrating a method of object recognition based on sensor fusion according to another embodiment of the present disclosure.

In the present disclosure, the first sensor described in FIG. 4 may be exemplified as the LiDAR sensor 104b or the radar sensor 104c that provides nearby objects as point cloud data. The second sensor may be exemplified as the image sensor 104a that provides nearby objects as image data. For convenience of description, a reference symbol of the LiDAR sensor 104b or the radar sensor 104c may be indicated with the first sensor, and a reference symbol of the image sensor 104a may be indicated with the second sensor. In addition, the method of the present disclosure is performed by the processor 120, but for convenience of description, the processor 120 and the vehicle 100 may be described interchangeably.

Referring to FIG. 4, the vehicle 100 may identify a track area including a static object of the road detected by the first sensors 104b and 104c that generate point cloud data as a candidate track area related to a road facility (S105).

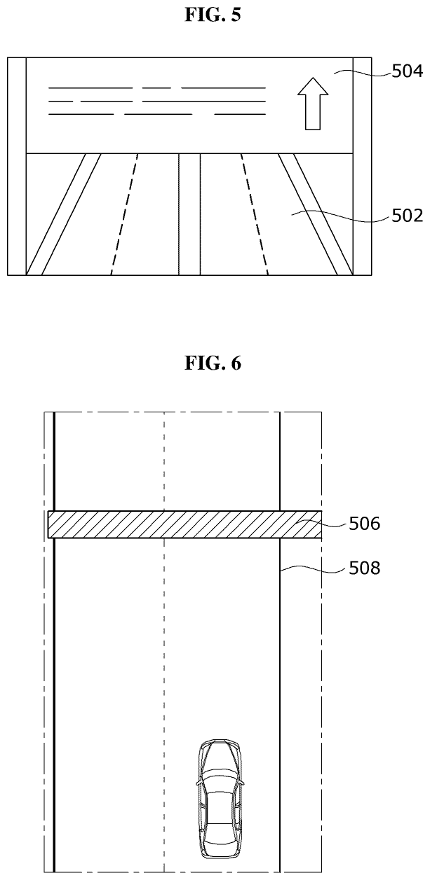

The first sensor 104b or 104c may be the LiDAR sensor 104b or the radar sensor 104c. In the following description, the first sensor is exemplified as the LiDAR sensor 104b for convenience of description, but the radar sensor 104c is not excluded. The road facility may be a structure that provides various types of information for the driving of the vehicle 100, or the road facility may be a special structure that is present on the road in a fixed manner or temporarily. In the following, for convenience of description, the road facility may be exemplified as a structure that provides information for driving. A road facility 504 that provides information for driving may be installed at a predetermined height from the ground of a road 502, as illustrated in FIG. 5. FIG. 5 is a diagram illustrating a road facility. Specifically, the road facility may be a road marker, a traffic sign, a traffic light, etc.

The track area may be generated by detecting an object based on sensor data acquired from the first sensor 104b, such as LiDAR data, and assigning a boundary area that identifies an object in a predetermined space by a LiDAR-based object recognition model. A track identifier is assigned to the track area, and object information may be added to the track identifier. The object information may include data estimated by the object recognition model, such as a type of object, the location of the object, the size of the object, the shape of the object, the speed of the object, etc. The processor 120 may continuously identify the location, speed, direction, etc., of the object through the track area and may perform location tracking of the object in a predetermined space as time passes.

The processor 120 may select a track area that satisfies a specific condition among multiple track areas as a candidate track area. The track area that satisfies the specific condition may include, for example, a static object that is located at a predetermined height from the ground of the road 502 among the static object that do not move.

Referring to FIG. 4, the processor 120 may manage the track area (S110).

The processor 120 may compensate for the position of the track area of the object according to the amount of movement of the vehicle 100, for example, with a sensor fusion cycle between the first sensor 104b and the second sensor 104a. This position compensation may be dead reckoning. The processor 120 may delete invalid track areas that deviate from an area of interest or a field of view (FoV) in the space including the track area to reduce computational and memory resources.

The processor 120 may compare the track area generated in operation S105 with the track area generated before operation S105 by using the associated area according to the predicted tracking model. The predicted tracking model may use, for example, a Kalman filter, an associated algorithm, or a learning-based algorithm. The predicted tracking model may provide an associated area predicted based on the behavior of the previous track area, for example, a gate having a specific range in vertical and horizontal directions. When both track areas overlap and match the gate, the processor 120 may update the track area before operation S105 to the track area of operation S105 and may assign the previous track identifier to the updated track area. When both track areas do not overlap or match the gate, the processor 120 may manage the track area of operation S105 as a new track area and assign a new track identifier to the new track area. The above-described update and separation management of the track area may be substantially equally applied to the candidate track area.

Referring to FIG. 4, the processor 120 may generate fusion information including verification data of a candidate track area based on fusion between at least one of the recognition area of the sensor, the map information, or the external information and the candidate track area (S115).

The verification data may include first verification data and second verification data.

The first verification data may be generated based on fusion between at least one of the first recognition area of the sensor or map information for static object different from the road facility 504 and the candidate track area to determine whether the candidate track area is a drivable area.

The static object different from the road facility 504 may be arranged in a direction intersecting the driving direction of the road and may include a boundary marker that guides driving on a road. The boundary marker may be, for example, a lane, a traffic marker with a function similar to lanes. The traffic marker may be, for example, a guardrail, a rubber cone, a tubular marker, etc., and as long as a traffic marker can guide driving on the road, the traffic marker is not limited to the examples described above.

In relation to the first verification data according to the fusion with the first recognition area, the sensor detecting the different static object may be the first sensor 104b or the second sensor 104a. The first recognition area generated by the first sensor 104b, i.e., the LiDAR sensor 104b, may include the different static object. The first recognition area may be generated from the LiDAR data by a LiDAR-based object recognition model. As another example, the first recognition area generated by the second sensor 104a, i.e., the image sensor 104a, may include the different static object. The first recognition area of the image sensor 104a may be generated from image data by an image-based object recognition model. For convenience of description, the sensor related to the first recognition area is exemplified as the second sensor 104a.

The processor 120 may determine the static object in the first recognition area as a road boundary marker when the static object in the first recognition area is greater than or equal to reference estimated reliability related to a road boundary marker, such as a lane.

The processor 120 may fuse a candidate track area 506 and the first recognition area of the second sensor 104a, as illustrated in FIG. 6. FIG. 6 is a diagram illustrating the generation of first verification data based on fusion between a boundary marker detected in a first recognition area of a sensor and a candidate track area. The processor 120 may determine whether the candidate track area 506 intersects an array form of a boundary marker 508 detected in the first recognition area. The processor 120 may determine the candidate track area 506 as a drivable area based on the intersection of the candidate track area 506 and the boundary marker 508. Specifically, the processor 120 may estimate that a portion below a road facility related to the candidate track area 506 is a road corresponding to the drivable area. Next, the processor 120 may generate first verification data having level data related to the determination of the drivable area according to the fusion of the first recognition area.

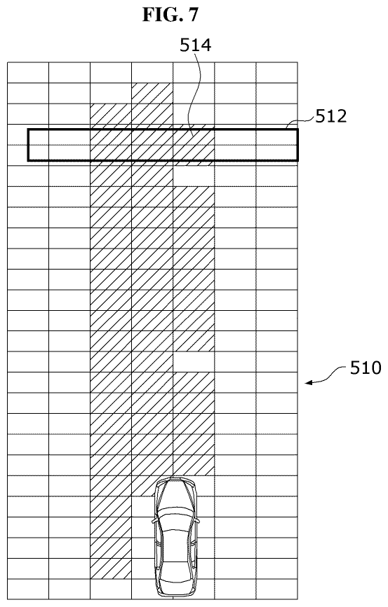

In relation to the first verification data according to the fusion with the map information, the processor 120 may load map information indicating locations of static object and dynamic object on the road 502 on which the vehicle is driven. The map information 510 may be an occupancy grid map, which is a type of occupancy map information, as illustrated in FIG. 7. FIG. 7 is a diagram illustrating the generation of the first verification data based on fusion between map information and the candidate track area.

The map information may have the degree of static estimation and the degree of dynamic estimation for each grid cell. The processor 120 may fuse the candidate track area 512 with the map information 510. The processor 120 identifies whether the degree of dynamic estimation is present in a grid cell 514 in the vicinity of the candidate track area 512, and when the estimation map is present, the degree of dynamic estimation in the vicinity of the candidate track area 512 may be confirmed. The grid cell 514 in the vicinity of the candidate track area 512 may be a grid cell that overlaps or is adjacent to the candidate track area 512.

The processor 120 may determine that the candidate track area 512 is a drivable area based on a dynamic tracking value of the nearby grid cell 514 being greater than or equal to a dynamic threshold value. Specifically, the processor 120 may estimate that a portion below the road facility related to the candidate track area 512 is a road corresponding to the drivable area. Next, the processor 120 may generate first verification data having level data related to the determination of a drivable area according to the fusion of map information.

Meanwhile, the second verification data may be generated to determine whether the static object is a candidate track area that estimates a road facility based on the fusion between at least one of the second recognition area of the second sensor 104a that detects image data including static object identical to the road facility 504, the map information or the external information and the candidate track area.

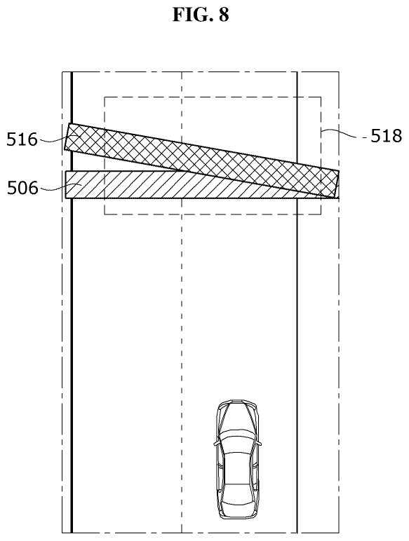

In relation to the second verification data according to the fusion with the second recognition area, the second recognition area generated by the second sensor 104a, i.e., the image sensor 104a, may include the road facility 504. The second recognition area may be generated from the image data by the image-based object recognition model. The processor 120 may fuse the candidate track area 506 and the second recognition area of the second sensor 104a, as illustrated in FIG. 8. FIG. 8 is a diagram illustrating the generation of the second verification data based on the fusion between the road facility detected in the second recognition area of the second sensor and the candidate track area.

The processor 120 may determine whether the candidate track area 506 matches an object 516 related to the road facility of the second recognition area. The matching may identify, for example, whether the candidate track area 506 and the facility-related object 516 completely overlap a gate 518 having a predetermined size. Based on the matching determination, the processor 120 may generate second verification data having level data related to facility estimation according to the fusion of the second recognition area.

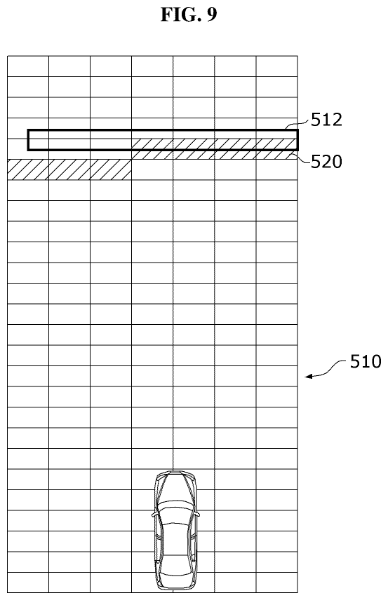

In relation to the second verification data according to the fusion with the map information, the processor 120 may load the map information. The map information 510 may be an occupancy grid map, as illustrated in FIG. 9. FIG. 9 is a diagram illustrating the generation of the second verification data based on the fusion between the map information and the candidate track area.

The processor 120 may fuse the candidate track area 512 with the map information 510. The processor 120 identifies whether a degree of static estimation is present in a grid cell 514 in the vicinity of the candidate track area 512, and when the estimation map is present, the degree of static estimation in the vicinity of the candidate track area 520 may be confirmed. The grid cell 514 in the vicinity of the candidate track area 512 may be a grid cell that overlaps or is adjacent to the candidate track area 520.

The processor 120 may determine that the candidate track area 512 matches the static object estimated as the road facility 504 in the map information 510 based on the static tracking value of the nearby grid cell 514 being greater than or equal to the static threshold value. Next, the processor 120 may generate second verification data having level data related to facility estimation according to the fusion of map information.

In relation to the second verification data according to the fusion with external information, the processor 120 may receive external information from the server 200, the ITS device 300, and another vehicle 400 through V2X communication. In addition, when the vehicle 100 obtains or possesses map information, for example, a high-precision map, the processor 120 may load the high-precision map.

The processor 120 may fuse the candidate track area with at least one of the external information or the high-precision map. The processor 120 may determine whether the candidate track area matches an object related to a road facility in the external information or the high-precision map. Based on the matching determination, the processor 120 may generate second verification data having a level data related to facility estimation according to the external information or the high-precision map.

Describing the level data included in the first and second verification data, the level data of the second verification data based on the fusion of the second recognition area as illustrated in FIG. 8 may be generated to have a higher reliability score than the level data of the second verification data based on the fusion of the map information as illustrated in FIG. 9. In addition, the level data of the second verification data based on the fusion of the second recognition area may be generated to have a higher reliability score than the level data of the first verification data according to FIGS. 6 and 7. In addition, level data on a candidate track area based solely on the first sensor 104b, i.e., the LiDAR sensor 104b, may be generated to have a lower reliability score than the level data of the second verification data based on the fusion of map information and the level data of the first verification data.

The level data of the second verification data based on the fusion of the external information or the high-precision map may be generated to have an arbitrary reliability score. When the external information or the high-precision map has accurate object information related to the road facility, such as facility information, the reliability score of the external information or the high-precision map may be higher than the reliability score of the level data according to FIGS. 6, 7, and 9.

For example, the reliability score may be provided as a numerical value or multiple levels. The multiple levels are a high level, a middle level, and a low level, and the reliability scores corresponding to each level may have the same numerical value.

Referring to FIG. 4, the processor 120 of the vehicle 100 may evaluate the reliability of the candidate track area based on the fusion information including the first and second verification data (S120).

The processor 120 may evaluate the reliability of the candidate track area based on, for example, the accumulated reliability score of the level data provided in the first and second verification data.

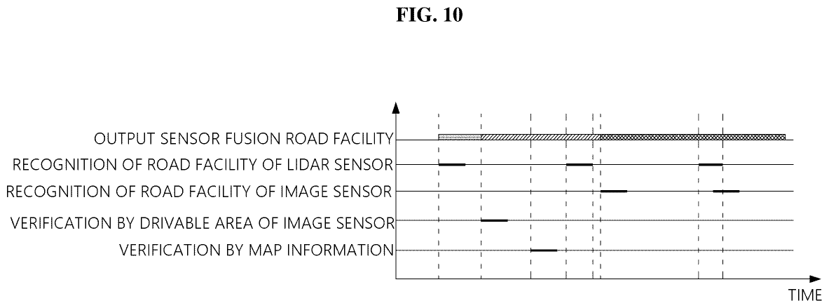

FIG. 10 is a diagram illustrating the reliability evaluation of a candidate track area and the determination of a track area including a facility according to an embodiment of the present disclosure. In FIG. 10, for convenience of description, the first sensor and the second sensor may correspond to the LiDAR sensor 104b and the image sensor 104a.

The reliability score related to the candidate track area recognizing the road facility by the LiDAR sensor 104b may be a low level according to the grade of the level data described above. As illustrated in the road facility recognition of the LiDAR sensor 104b of FIG. 9, the reliability determined to output the candidate track area including a static object of the road facility may be evaluated as a low level due to the LiDAR sensor 104b alone. The processor 120 may not determine the candidate track area as a road facility based on the reliability evaluation result described above.

The reliability score related to the determination of the drivable area based on the first recognition area of the image sensor 104a and the first and second verification data based on the fusion with the map information may be a middle level according to the grade. When the reliability score described above is generated, the reliability used for the output determination may be increased due to the higher reliability score and the accumulation of scores compared to the LiDAR sensor 104b alone. The reliability is increased, but depending on the setting, the processor 120 may restrictively determine the candidate track area as a road facility based on the reliability evaluation result described above. The restricted determination may include determining the candidate track area as a road facility when a specific condition is met.

The reliability score related to the recognition (or determination) of the road facility estimation based on the fusion with the second recognition area of the image sensor 104a may be a high level according to the grade. When the reliability score described above is generated, the reliability may be increased due to the higher reliability score and the accumulation of the scores compared to the fusion with the map information.

Referring to FIG. 4, the processor 120 may determine the candidate track area as a track area that includes a static object of the road facility based on the reliability evaluation result and may generate track information related to the track area (S125).

As illustrated in FIG. 10, after the reliability score related to the fusion with the second recognition area is generated and the reliability is evaluated as a high level, the processor 120 may finally determine the candidate track area of the road facility newly recognized by the LiDAR sensor 104b as a track area that includes a static object of the road facility. The track information may include the object information and the track identifier described in FIG. 2.

Referring to FIG. 10, it can be seen that the newly recognized candidate track area is determined as a road facility before the recognition of the image sensor 104a that is performed subsequently. The method according to FIG. 10 may realize higher recognition performance and faster object estimation for track areas than the method in which respective tracks in which the LiDAR sensor 104b and the image sensor 104a simultaneously recognize static object are fused.

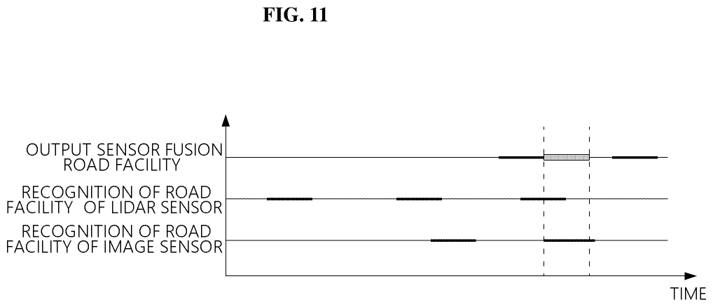

FIG. 11 is a diagram illustrating the determination of a track area including a facility according to the recognition of individual sensors. Referring to FIG. 11, even when a static object estimated as a road facility is recognized by the LiDAR sensor 104b, the track area of the LiDAR sensor 104b is determined as a road facility after the image sensor 104a that overlaps the recognition time of the LiDAR sensor 104b recognizes the road facility. Comparing the determination of the track area of FIGS. 10 and 11, the determination of the track area as a road facility in FIG. 10 may be faster than that in FIG. 11. In addition, for rapid object estimation, even when the map information, the recognition result of the image sensor 104a, and the external information are used for fusion with the recognition result of the LiDAR sensor 104b, the robustness of object recognition may be secured by the generation and reliability evaluation of the fusion information according to S115 and S120.

Referring to FIG. 4, the processor 120 may control the vehicle 100 based on the track information (S130). The control of the vehicle 100 may include, for example, longitudinal control and lateral control. Also, the control of the vehicle 100 may include the autonomous driving.

In the above description, the road facility recognized by the first sensor 104b and the second sensor 104a is described as an object spaced apart from the ground of the road at a predetermined height. The method of FIG. 4 may also be applied to object recognition for road facilities in contact with the ground of the road. Here, the road facility may be equipment (or an irregular/non-standard structure) fixed or movable in a construction or dangerous section, as described in FIG. 2, or a traffic structure installed in the section.

When the road facility is a static object such as a guard rail and a road boundary marker, the candidate track area in operation S105 may be selected as a track area having a static object in contact with the ground. Operations S110 to S130 may be applied to the recognition of the road boundary marker within a technically non-conflicting range. When the track area is determined to be a road boundary marker, the processor 120 of the vehicle 100 may change to activate a flag of positioning risk and control the vehicle 100 based on the flag.

When the road facility is a dynamic object such as construction equipment, the candidate track area in step S105 may be selected as a track area having a dynamic object in contact with the ground. Operations S110 to S130 may be applied to the recognition of construction equipment within a technically non-conflicting range. When the track area is determined as construction equipment, the processor 120 of the vehicle 100 may change to activate a flag of control risk and control the vehicle 100 to perform emergency braking based on the flag.

According to the present disclosure, the method of object recognition based on sensor fusion to improve the robustness of object recognition through various types of sensor fusion and the vehicle for implementing the same can be provided.

Effects, which can be achieved by the present disclosure, are not limited to the above-described effects. In other words, other objects that are not described may be obviously understood by those having ordinary skill in the art to which the present disclosure pertains from the following description.

While the methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the present disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for recognizing an object based on sensor fusion, the method comprising:
identifying, as a candidate track area associated with a road facility, a track area including a static object on a road, the static object being detected by a first sensor configured to generate point cloud data;
generating fusion information including first verification data and second verification data associated with the candidate track area;
evaluating reliability of the candidate track area based on the fusion information; and
determining, based on the reliability, the candidate track area as a track area including a static object of the road facility,
wherein the first verification data is generated to determine whether the candidate track area is a drivable area based on fusion between at least one of a first recognition area or map information of a sensor for static object different from the road facility and the candidate track area, and
wherein the second verification data is generated to determine whether the static object is the candidate track area estimated as the road facility based on fusion between at least one of a second recognition area or the map information of a second sensor detecting image data including the static object identical to the road facility and the candidate track area.

2. The method of claim 1, wherein identifying the candidate track area includes identifying the track area including the static object located at a predetermined height from a ground of the road as the candidate track area.

3. The method of claim 1, wherein the first sensor includes a LiDAR sensor or a radar sensor.

4. The method of claim 1, wherein the recognition area of the sensor used to generate the first verification data includes the recognition area of the first sensor or the second sensor.

5. The method of claim 1, wherein the different static object detected in the first recognition area includes boundary markers that guide driving on the road, and
wherein the first verification data is generated to have level data related to the determination of the drivable area based on the candidate track area being determined as the drivable area, wherein the candidate track area intersects an array form of the boundary marker detected in the first recognition area.

6. The method of claim 1, wherein the map information includes a degree of dynamic estimation, based on a location of the road on which the static object and a dynamic object are present, and a trajectory of the dynamic object, and
wherein when the degree of dynamic estimation around the candidate track area is greater than or equal to a dynamic threshold value, the first verification data is generated to have level data related to the determination of the drivable area based on the candidate track area being determined as the drivable area.

7. The method of claim 1, wherein the second verification data is generated to have level data related to the estimation of the road facility based on the candidate track area being matched to the second recognition area including an object identical to the road facility.

8. The method of claim 1, wherein the map information includes a degree of static estimation, based on a location of the road on which the static object and a dynamic object are present, and a location of the static object, and
wherein when the degree of static estimation around the candidate track area is greater than or equal to a static threshold value, the second verification data is generated to have level data related to the estimation of the road facility based on the candidate track area being estimated as the road facility.

9. The method of claim 1, wherein level data of the second verification data based on the fusion of the second recognition area is generated to have a higher reliability score than level data of the second verification data based on the fusion of the map information and level data of the first verification data,
wherein level data about the candidate track area based on the first sensor is generated to have a lower reliability score than the level data of the second verification data based on the fusion of the map information and the level data of the first verification data, and
wherein evaluating the reliability includes evaluating the reliability of the candidate track area based on an accumulated reliability score of the level data.

10. The method of claim 1, wherein the fusion of the candidate track area for generating the second verification data uses at least one of the second recognition area, the map information, or external information, and
wherein the external information is received from at least one of a transportation device, a traffic infrastructure device, or a support server around a device equipped with a sensor and includes facility information related to the road facility.

11. A vehicle configured to perform object recognition based on sensor fusion, the vehicle comprising:
a sensor unit including a first sensor configured to generate point cloud data and a second sensor configured to generate image data in relation to detection of a surrounding environment;
a memory configured to store at least one instruction; and
at least one processor configured, by executing the at least one instruction stored in the memory to:
identify a track area including a static object on a road detected by the first sensor as a candidate track area related to a road facility;
generate fusion information including first verification data and second verification data in relation to the candidate track area;
evaluate reliability of the candidate track area based on the fusion information; and
determine the candidate track area as a track area including a static object of the road facility based on the reliability,
wherein the first verification data is generated to determine whether the candidate track area is a drivable area based on fusion between at least one of a first recognition area or map information of a sensor for static object different from the road facility and the candidate track area, and
wherein the second verification data is generated to determine whether the static object is the candidate track area estimated as the road facility based on fusion between at least one of a second recognition area or the map information of a second sensor including the static object identical to the road facility and the candidate track area.

12. The vehicle of claim 11, wherein the at least one processor is further configured to identify the track area including the static object located at a predetermined height from a ground of the road as the candidate track area.

13. The vehicle of claim 11, wherein the first sensor includes a LiDAR sensor or a radar sensor.

14. The vehicle of claim 11, wherein the recognition area of the sensor used to generate the first verification data includes the recognition area of the first sensor or the second sensor.

15. The vehicle of claim 11, wherein the different static object detected in the first recognition area includes boundary markers that guide driving on the road, and
wherein the first verification data is generated to have level data related to the determination of the drivable area based on the candidate track area being determined as the drivable area, wherein the candidate track area intersects an array form of the boundary marker detected in the first recognition area.

16. The vehicle of claim 11, wherein the map information includes a degree of dynamic estimation based on a location of the road on which the static object and a dynamic object are present and a trajectory of the dynamic object, and
wherein when the degree of dynamic estimation around the candidate track area is greater than or equal to a dynamic threshold value, the first verification data is generated to have level data related to the determination of the drivable area based on the candidate track area being determined as the drivable area.

17. The vehicle of claim 11, wherein the second verification data is generated to have level data related to the estimation of the road facility based on the candidate track area being matched to the second recognition area including an object identical to the road facility.

18. The vehicle of claim 11, wherein the map information includes a degree of static estimation based on a location of the road on which the static object and a dynamic object are present and a location of the static object, and
wherein when the degree of static estimation around the candidate track area is greater than or equal to a static threshold value, the second verification data is generated to have level data related to the estimation of the road facility based on the candidate track area being estimated as the road facility.

19. The vehicle of claim 11, wherein level data of the second verification data based on the fusion of the second recognition area is generated to have a higher reliability score than level data of the second verification data based on the fusion of the map information and level data of the first verification data,
wherein level data about the candidate track area based on the first sensor is generated to have a lower reliability score than the level data of the second verification data based on the fusion of the map information and the level data of the first verification data, and
wherein the at least one processor is further configured to evaluate the reliability of the candidate track area based on an accumulated reliability score of the level data.

20. The vehicle of claim 11, wherein the fusion of the candidate track area for generating the second verification data uses at least one of the second recognition area, the map information, or external information, and
wherein the external information is received from at least one of a transportation device, a traffic infrastructure device, or a support server around a device equipped with a sensor and includes facility information related to the road facility.
